(19) United States
(12) Patent Application Publication
(10) Pub. No.: US 2001/0007995 A1
(43) Pub. Date: Jul. 12, 2001

(54) Output service system

(76) Inventor: Yoshinobu Makino, Kaisei-machi (JP)

Correspondence Address: BIRCH, STEWART, KOLASCH & BIRCH, LLP, P.O. BOX 747, FALLS CHURCH, VA, 22040-0747, US

(21) Appl. No.: 09/757,644

(22) Filed: Jan. 11, 2001

(30) Foreign Application Priority Data
Jan. 11, 2000 (JP) 002607/2000

(51) Int. Cl. G06F 15/16

(52) U.S. Cl. 709/219; 709/203; 709/217

(57) ABSTRACT

In a system for carrying out output services such as printing image data based on an order from a client, a load on the system such as a data transmission load can be reduced. A user describes an image-data printing order in order information, and transfers the order information to an agency. The order information includes, as a pointer, a URL of a personal computer of the user which stores the image data. The agency confirms the order information and assigns the order to a laboratory. The laboratory transmits a transfer request for the image data to the personal computer of the user, based on the pointer described in the order information. The personal computer transfers the image data to the laboratory, in response to the transfer request. The laboratory 3 prints the image data from a printer, by referring to the order information.

### BACKGROUND OF THE INVENTION

1. Field of the Invention

The present invention relates to an output service system for outputting material data such as image data and audio data according to order information, and to an order output method and an order output apparatus for outputting the material data based on the order information. The present invention also relates to a computer-readable recording medium storing the order information.

2. Description of the Related Art

Digital photographic service systems carrying out various digital photographic services related to photographs, such as storing photograph images obtained by users in image servers after digitization thereof, providing the images to the users by recording the images in CD-Rs, and receiving orders for additional prints, have been known. In such a system, a user installs dedicated viewer software for reproducing an image recorded in a CD-R in his/her personal computer, and reproduces the image. The user generates order information describing the content of an order by using an ordering function of the viewer software in the case of ordering an additional print. The user brings the order information and the CD-R to a DPE store and the DPE store provides the order information and the CD-R to a laboratory. In this manner, a photograph image that has been ordered is generated.

As one form of such digital photographic service systems, a network photographic service system has been proposed. In a network photographic service system, digital images of users are stored (registered) in a system of a service provider and a printing order or the like is received via a network such as the Internet.

In such a network photographic service system, in order to provide digital photographic services to users, a server computer having a scanner, a printer, and a large-capacity disc (hereinafter called an image server) is installed in a wholesale laboratory and photographs obtained by users are stored in the image server. By enabling the users to access the image server via a network, various kinds of services such as ordering an additional print, attaching a photograph image to an e-mail message, and download of photographic image data are provided. In such a service, a user accesses the image server by using predetermined application software installed in his/her personal computer and orders an additional print or the like. Meanwhile, in the laboratory, photographic processing such as trimming and generation of an additional print, a picture postcard, an album, and a composite image is carried out on image data based on order information from the user. Data after the processing are transferred to the user or an e-mail message notifying completion of the processing is sent to the user, for example.

The “order information” herein referred to is information such as a processing number indicating the content of a service (such as generation of an additional print or a postcard), an image number specifying a photograph, a print size, the quantity of prints, a quality of printing paper (such as glossy or non-glossy), the thickness of the paper, the content of photographic processing, and trimming specification, for example.

In such a network photographic service system, an output service for printing images on T-shirts, mug cups, jigsaw puzzles, or on faces of watches has been carried out and provided to users. Furthermore, output services for registering material data such as image data, audio data, movie data, and computer programs owned by users in a database or recording in recording media such as CD-Rs have also been carried out. In such a case, a user specifies the content of an output service by using order information and transfers the information to a laboratory. Alternatively, the order information is recorded in a recording medium and brought to the laboratory. Based on the order information, the laboratory can provide the output services such as described above to the user.

In the case where a photographic image is printed based on such order information, the laboratory does not have the image data in some cases. In such a case, the user needs to transfer the image data to be printed via a network, together with the order information. Alternatively, the user needs to record the image data and the order information in a recoding medium and brings the recording medium to the laboratory to provide the image data and the order information. Moreover, in the case of the service for outputting the material data described above, the material data also need to be provided to the laboratory, together with the order information. The size of the order information is small, since only the content of the service is described therein. However, the material data such as image data are larger in size. Therefore, in the case where the necessary data are transferred from the user to the laboratory via the network, a transmission load is heavy, which leads to a long transmission time. Especially, in the case of data transmission, since the user pays a communication charge for a telephone line necessary for access to the network, such a long data transmission time is costly for the user. In the case where the data and the information are provided to the laboratory in the form of a recording medium, the recoding medium needs to have a comparatively large capacity, which is also costly for the user.

In a network photographic service system, a center server for collecting orders from users and transfers the necessary data and order information to the laboratory may be used in some cases. In such a case, the data need to be transferred twice, form the user to the center server, then from the center server to the laboratory. Therefore, data transmission is time-consuming. Especially, in the case where the center server comprises DPE stores and a server for collecting the orders from the DPE stores, the number of data transmission times increases, which leads to a substantially heavy load of data transmission. Moreover, in the laboratory, the large-size data need to be received. Therefore, high data-processing performance is necessary in the case of busy transmission of order information. As a result, installation and maintenance of the system becomes substantially costly. The high data-processing performance refers to a high processing speed, a large amount of data to be processed at once, and a capacity of a buffer for temporarily storing data in the case of busy data transmission, for example.

### SUMMARY OF THE INVENTION

The present invention has been conceived based on consideration of the above problems. An object of the present invention is therefore to provide an output service system, an order output method and an order output apparatus enabling reduction of a load on a user at the time of ordering output of material data, and a computer-readable recording medium storing order information.

An output service system of the present invention comprises:

at least one client for generating order information for ordering output of material data; and

at least one output server for outputting the material data based on the order information provided from the client or clients, and the system is characterized in that the order information includes a pointer for obtaining the material data; and

the output server or output servers obtain the material data stored at a location other than the output server or output servers based on the pointer included in the order information.

The “output of the material data” refers to not only printing of a photograph using image data or generation of an additional print or a postcard, but also generation of a mug cup, a jigsaw puzzle, a T-shirt, a face of a watch or the like having an image printed thereon, or storing image data, audio data, movie data, a computer program or the like in a database or in a recording medium such as a CD-R.

The order information may be provided to the output server or output servers via a network, or by being recorded in a recording medium.

The “pointer” refers to a URL on the Internet, UNC used in the Windows systems, and the like.

“Obtaining the material data stored at a location other than the output server or output servers” excludes the case of obtaining the material data stored in the output server or output servers.

The output service system of the present invention may further comprise a relay server existing between the at least one client and the at least one output server. The relay server selects one of the at least one output server as an apparatus for outputting the material data according to the order information from the at least one client and provides the order information to the selected server.

In this case, the relay server may comprise servers at a plurality of steps.

The “relay server” refers to a DPE store or the like for receiving an order from a user. As the “servers at a plurality of steps”, not only the DPE store but also a service center for collecting the orders from the DPE store and assigning the order information to the at least one output server may be used.

An order output method of the present invention is a method of outputting material data according to order information and the order information includes a pointer to obtain the material data. The order output method comprises the steps of:

obtaining the material data based on the pointer included in the order information; and

outputting the material data that have been obtained.

An order output apparatus of the present invention is an apparatus for outputting material data according to order information, and the order information includes a pointer to obtain the material data. The order output apparatus comprises:

acquisition means for obtaining the material data based on the pointer included in the order information; and

output means for outputting the material data.

The order output method of the present invention may be provided as a program stored in a computer-readable recording medium to cause a computer to execute the order output method.

Furthermore, the order information including the pointer to obtain the material data may be provided by being recorded in a recording medium.

According to the present invention, each of the at least one client (hereinafter called the client) provides only the order information to one of the at least one output server (hereinafter called the output server) and the output server obtains the material data stored in a location other than the output server based on the pointer included in the order information for obtaining the material data. The material data are output based on the order information. Therefore, in the present invention, since the client provides to the output server only the order information having a small size, a transmission load on the network can be reduced and the user can reduce the cost such as an access fee in the case where the order information is provided via the network. Furthermore, in the case where the order information is provided by being recorded in a recording medium, a large-capacity disc is not necessary, which can also reduce the cost for the user.

Especially, in the case where a client and an output server are connected via a network in a conventional system, the output server always has to be ready to receive order information and material data. Furthermore, the output server has to be capable of processing a large amount of data in the case of busy transmission of order information. On the other hand, in the present invention, the output server receives only the order information. Therefore, it is unnecessary for the output server to be ready for reception of a large amount of data. Moreover, when the material data are obtained, a large amount of data do not need to be obtained at once, and the material data are obtained sequentially according to data processing performance of the server, for example. Therefore, high data-processing performance is unnecessary. As a result, the output server can be installed at low cost.

In the case where the relay server is used between the client and the output server, the order information from the client is concentrated to the relay server. However, in this case, since only the order information having a small size is provided to the relay server, the relay server does not need to have high data-processing performance. Therefore, the relay server can be installed at low cost. Moreover, in the conventional system, the client provides the material data at the same time as providing the order information to the output server via the relay server. Therefore, the data need to be transferred twice, which leads to a long transmission time. According to the present invention, data transmission is carried out only once from the location of the material data indicated by the pointer to the output server. Therefore, transmission efficiency can be improved.

### BRIEF DESCRIPTION OF THE DRAWINGS

FIG. 1 is a block diagram showing a configuration of an output service system according to an embodiment of the present invention;

FIG. 2 shows the content of order information;

FIG. 3 is a flow chart showing processing in the embodiment;

FIG. 4 is a diagram showing transmission sequences of order information and image data in a conventional output service system;

FIG. 5 is a diagram showing a transmission sequence of order information and image data in the output service system according to the embodiment; and

FIG. 6 is a block diagram showing a configuration of another embodiment of the output service system according to the present invention.

### DESCRIPTION OF THE PREFERRED EMBODIMENTS

Hereinafter, embodiments of the present invention will be explained with reference to the accompanying drawings.

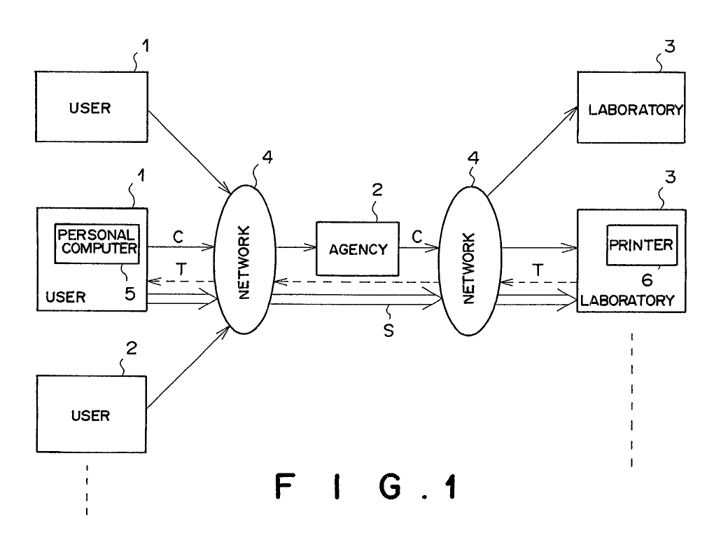

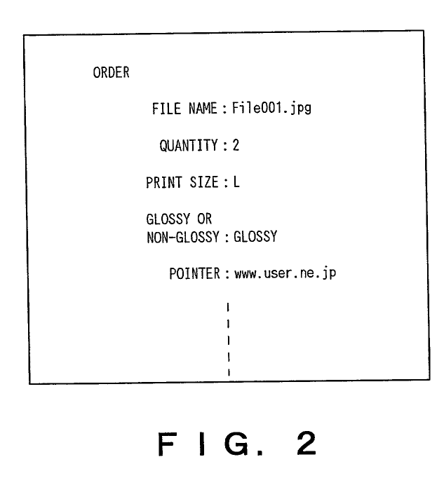

FIG. 1 is a block diagram showing a configuration of an output service system according to an embodiment of the present invention. As shown in FIG. 1, users 1, an agency 2 and laboratories 3 are connected via a network 4 in the output service system according to this embodiment. A personal computer 5 of each of the users 1 (hereinafter called the user 1) stores image data S owned by the user. The content of an order for printing the image data S is described as order information C and the order information C is transferred to the agency 2. FIG. 2 shows the content of the order information C. As shown in FIG. 2, the order information C includes, as the content of the order, a file name of an image whose printing is requested, the quantity of prints, a print size, whether glossy or non-glossy printing paper is used, and a pointer to indicate a location of the image data S. The pointer describes a URL of the personal computer 5 of the user 1 storing the image data S, such as “www.user.ne.jp”, for example.

The agency 2 receives the order information C from the user 1 and assigns one of the laboratories 3 to carry out printing, depending on the content of the order information C. For this assignment, one of the laboratories 3 close to the user 1 or one of the laboratories 3 enabling processing of the order requested by the user 1 is selected, for example. As the agency 2, a website in cooperation with the output service system may be used.

Each of the laboratories 3 (hereinafter called the laboratory 3) receives the order information transferred from the agency 2 and obtains the image data S by referring to the pointer described in the order information C. In this embodiment, the user 1 stores the image data S, and the pointer describes the URL of the user 1. Therefore, the laboratory 3 transmits a transfer request T for the image data S to the personal computer 5 of the user 1 and the personal computer 5 directly transfers the image data S to the laboratory 3 in response to the transmission request T, without involving the agency 2. The laboratory 3 prints the image data S from a printer 6 thereof, based on the order information C.

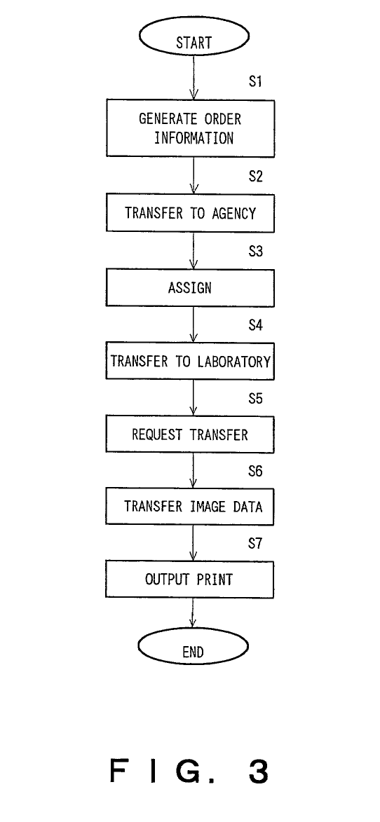

Operation of this embodiment will be explained next. FIG. 3 is a flow chart showing the operation of this embodiment. The user 1 generates the order information C to order printing (Step S1) , and transfers the information C to the agency 2 (Step S2). The order information C includes the pointer to the image data S, as has been described above. The agency 2 receives the order information C and confirms the content thereof. The agency 2 then assigns the laboratory 3 to carry out printing (Step S3), and transfers the order information C to the laboratory 3 (Step S4). The laboratory 3 receives the order information C and transmits the transfer request T for the image data S to the personal computer 5 of the user 1 by referring to the pointer described in the order information C (Step S5). The personal computer 5 of the user 1 receives the request T and transfers the image data S to the laboratory 3 (Step S6). The laboratory 3 prints the image data S from the printer 6 based on the order information C (Step S7) to end the procedure.

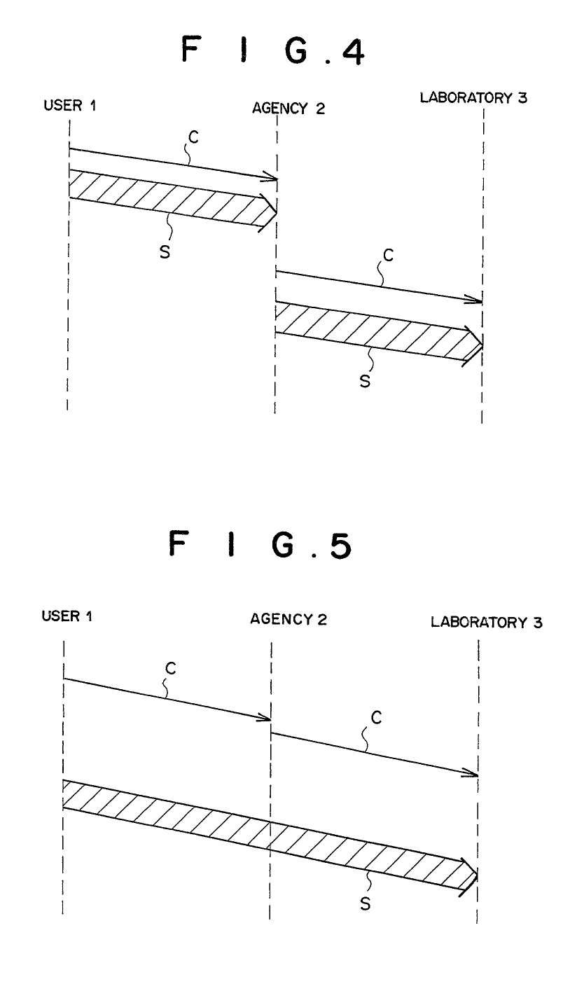

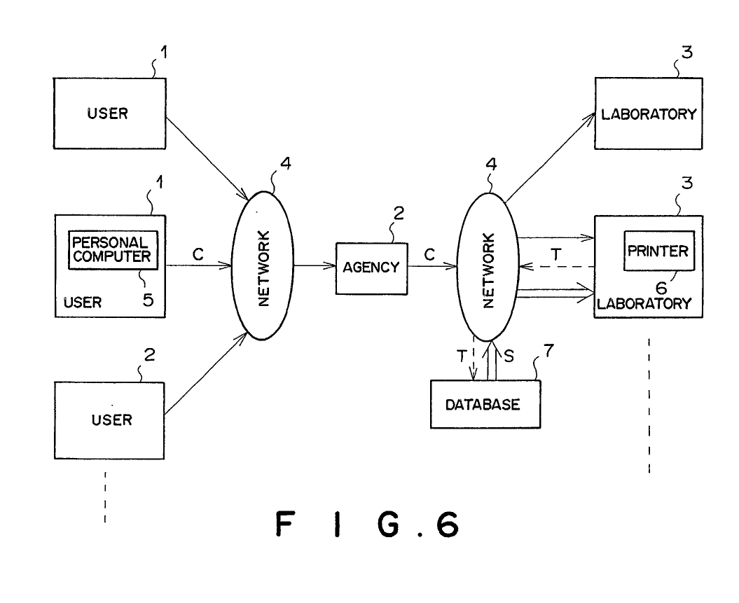

FIGS. 4 and 5 show transmission sequences of the order information C and the image data S in a conventional output service system and in this embodiment, respectively. In FIGS. 4 and 5, vertical axes show time elapsed. As shown in FIG. 4, in the conventional system, the order information C and the image data S are transferred twice, first from the user 1 to the agency 2 and then from the agency 2 to the laboratory 3. The image data S have a larger size compared to the order information C and need a longer time for transmission. Therefore, transmitting the image data S twice substantially reduces efficiency of the transmission. On the other hand, in this embodiment, only the order information C having the smaller data size is transferred twice but the image data S having the larger size are transferred only once. Therefore, the transmission efficiency can be improved.

According to this embodiment, the user 1 transfers to the agency 2 only the order information C having the smaller size. Therefore, a transmission load on the network 4 and the cost such as a communication fee charged to the user 1 can be reduced. Meanwhile, the laboratory 3 needs to communicate heavily especially for acquisition of the image data S. Therefore, it is preferable for the laboratory 3 to process more orders fast and at low cost by using a high-speed communication line or by contracting with a communication service company.

In the conventional system, the agency 2 and the laboratory 3 need to be constantly ready to receive the order information C and the image data S, and need high data-processing performance for the case of busy transmission of the order information C and the image data S. On the other hand, in this embodiment, the agency 2 and the laboratory 3 receive only the order information C. Therefore, the agency 2 and the laboratory 3 do not need to be constantly ready to receive a large amount of data.

When the laboratory 3 obtains the image data S, it is not necessary for the laboratory 3 to obtain the entire image data 3 having the large size at once. Depending on the processing performance of the laboratory 3, the image data S are obtained sequentially by accessing the location of the image data S. Therefore, high data-processing performance is not necessary, which leads to installation of the system of the laboratory 3 at lower cost.

In the above embodiment, the image data S to be printed are stored in the personal computer 5 of the user 1. However, in the case where the pointer indicating the location of the image data S in the order information C specifies a database 7 connected to the network 4 as shown in FIG. 6, the laboratory 3 transmits a transfer request T to the database 7, based on the pointer described in the order information C. The database 7 transfers the image data S to the laboratory 3 in response to the transfer request T. The laboratory 3 then carries out the printing as in the above embodiment.

In the above embodiment, the order information C is transferred from the user 1 to the agency 2 and then to the laboratory 3 via the network 4. However, the order information C may be recorded in a recording medium and brought to the agency 2 by the user 1. The order information is then sent from the agency 2 to the laboratory 3. Since the order information has a smaller size than the image data S, a low-cost recording medium such as an FD can be used and no large-capacity disc is necessary. Therefore, the user 1 can spend less on the recording medium.

In the above embodiment, the case of printing service of the image data S has been explained. However, in the case of services of other kinds, such as printing the image represented by the image data S on a mug cup, a T-shirt, a jigsaw puzzle, and a face of a watch, or storing the image data S, audio data, movie data, and computer programs in the database or in a recording medium such as a CD-R, printing or storage or recording of the data can be carried out as in the above embodiment, based on the pointer included in order information C for indicating the location of the data.

In addition, all of the contents of Japanese Patent Application No. 2000-002607 are incorporated into this specification by reference.

What is claimed is:

1. An output service system comprising:
at least one client for generating order information for ordering output of material data; and
at least one output server for outputting the material data based on the order information provided from the client or clients,
the order information including a pointer for obtaining the material data; and
the output server or output servers obtaining the material data stored at a location other than the output server or output servers based on the pointer included in the order information.

2. An output service system as defined in claim 1, further comprising a relay server existing between the at least one client and the at least one output server, the relay server selecting one of the at least one output server as an apparatus for outputting the material data according to the order information from the at least one client and providing the order information to the selected server.

3. An output service system as defined in claim 2, wherein the relay server comprises servers at a plurality of steps.

4. An output service system as defined in any one of claims 1 to 3, wherein the order information is provided to the output server or servers via a network.

5. An output service system as defined in any one of claims 1 to 3, wherein the order information is provided to the output server or servers by being recorded in a recording medium.

6. A computer-readable recording medium storing order information for ordering output of material data, the order information including a pointer to obtain the material data.

7. A method of outputting material data according to order information including a pointer for obtaining the material data, the order output method comprising the steps of:
obtaining the material data based on the pointer included in the order information; and
outputting the material data that have been obtained.

8. An order output apparatus for outputting material data according to order information including a pointer for obtaining the material data, the order output apparatus comprising:
acquisition means for obtaining the material data based on the pointer included in the order information; and
output means for outputting the material data that have been obtained.

9. A computer-readable recording medium storing a program to cause a computer to execute an order output method for outputting material data based on order information including a pointer for obtaining the material data, the program comprising the procedures of:
obtaining the material data based on the pointer included in the order information; and
outputting the material data that have been obtained.
